(19) United States
(12) Patent Application Publication
(10) Pub. No.: US 2022/0190643 A1
(43) Pub. Date: Jun. 16, 2022

(54) METHOD FOR CHARGING BY INDUCTION AND ASSOCIATED CHARGING DEVICE

(71) Applicant: Continental Automotive GmbH, Hannover (DE)

(72) Inventors: Laurent Grellat, Toulouse (FR); Mathieu Fiquet, Toulouse (FR); Frédéric Loiselle, Toulouse (FR)

(21) Appl. No.: 17/437,595

(22) PCT Filed: Mar. 20, 2020
(86) PCT No.: PCT/EP2020/057881

§ 371 Date: Sep. 9, 2021

(30) Foreign Application Priority Data
Mar. 21, 2019 (FR) FR1902927

(51) Int. Cl. H02J 50/10; H02J 50/40; H02J 50/80; H02J 50/90

(52) U.S. Cl. CPC H02J 50/10; H02J 50/90; H02J 50/80; H02J 50/402

(57) ABSTRACT

A method for induction charging a user's portable equipment using a charging device including at least two transmitter coils and having a charging surface for receiving the equipment for charging thereof. The charging device periodically receiving a signal from the portable equipment during charging, the signal including a value representing a deviation between a charging power required by the portable equipment and a charging power received by the equipment. The method includes: placing the portable equipment on the charging surface and activating a first charging coil; determining a charging conditions parameter; if the charging conditions parameter is greater than a predetermined threshold representing charging limit conditions, activate a coil adjacent to the charging coil while keeping the first coil activated; if the value representing the deviation between the required charging power and the received power is less than a first threshold, deactivate the first coil; otherwise, repeating the preceding steps.

### CROSS REFERENCE TO RELATED APPLICATIONS

This application is the U.S. National Phase Application of PCT International Application No. PCT/EP2020/057881, filed Mar. 20, 2020, which claims priority to French Patent Application No. 1902927, filed Mar. 21, 2019, the contents of such applications being incorporated by reference herein.

### FIELD OF THE INVENTION

The present invention relates to the field of motor vehicles and more specifically relates to a method for induction charging a battery of equipment of a user, as well as to an associated charging device and to a motor vehicle comprising such a device.

### BACKGROUND OF THE INVENTION

Numerous motor vehicles currently include an on-board charging module for recharging the battery of a mobile telephone.

This charger can comprise a connector to which the telephone is connected or even a surface on which the telephone is placed in order for it to be recharged by induction.

In this latter solution, the induction charging device comprises at least one transmitter antenna and the telephone comprises a receiver antenna assuming the form of a coil disposed substantially at the center of the telephone, in particular in order to allow good balancing thereof and sufficient charging efficiency, as prescribed, for example, in the WPC (“Wireless Power Consortium”) standard.

To perform inductive coupling for efficiently recharging the battery of the telephone, the center of the receiver antenna thereof needs to be substantially aligned with the center of one of the transmitter antennas of the device, with a tolerance of the order of 10 mm.

Moreover, the device needs to comprise a plurality of antennas when intending to cover a large charging surface, thereby making the device complex and expensive. Otherwise, the telephone needs to be moved in order to align its receiver antenna with the transmitter antenna of the device, which is a major drawback.

In all cases, when the vehicle moves, the mobile telephone can be subject to numerous movements, and the driver then has to constantly realign the telephone with the transmitter antenna while driving, which can prove dangerous, and therefore is a major drawback.

One known solution for solving this drawback involves using a charging device, the one or more transmitter antenna(s) of which are motorized so as to move in order to increase the charging surface and no longer have to manually align the telephone with the transmitter antenna. Such a solution is extremely complex and expensive, which is a major drawback, in particular for entry-level vehicles. In addition, such a motorized charging device is not necessarily suitable for a wide range of telephone sizes, which is a major drawback.

Another solution of the prior art involves switching the charging coil as a function of the movement of the telephone, when said telephone no longer receives enough charging power. Indeed, when the telephone is off-centered relative to the charging coil that is activated, the telephone no longer receives enough power and consequently either the telephone stops charging or it sends a stop charging request to the charging device. Said charging device then restarts a method for finding a charging antenna that is most aligned with the telephone, i.e. most capable of efficiently charging the telephone. This procedure is implemented by each charging antenna of the device sequentially sending a “digital ping”, i.e. current pulses, the coil that is most aligned with the telephone will receive a response to this digital ping, and the charging device will activate the charge via this antenna.

The drawback of this method for switching antenna during charging is that it is accompanied by the charging temporarily stopping, and by audible, visual or vibrating notifications intended for the user when charging is stopped and is restarted, which can prove to be highly disruptive for the user while driving their vehicle.

### SUMMARY OF THE INVENTION

An aim of an aspect of the invention is to provide a recharging solution that is equally simple, reliable, efficient and inexpensive.

An aspect of the invention proposes a method for induction charging portable equipment of a user using a charging device comprising at least two transmitter coils and having a charging surface capable of receiving said equipment for the charging thereof, said charging device periodically receiving a signal from the portable equipment during charging, said signal comprising a value representing a deviation between a charging power required by the portable equipment and a charging power received by said equipment, the method being characterized in that it comprises the following steps:
placing the portable equipment on the charging surface and activating a first charging coil (step E0);
determining a charging conditions parameter (step E1);
if the charging conditions parameter is greater than a predetermined threshold representing charging limit conditions (step E1), then
activating a coil adjacent to said charging coil whilst keeping the first coil activated (step E2);
if the value representing the deviation between the required charging power and the received power is less than a first threshold (step E4), then
deactivating the first coil (step E5);
otherwise, repeating the preceding steps.

According to the method of an aspect of the invention, the charging conditions parameter is computed on the basis of a value of the direct voltage at the input of an AC-to-DC converter connected to the first charging coil, a value of the direct current at the input of said converter, a value of the alternating current circulating in the first charging coil, a value of the alternating voltage at the terminals of said first charging coil and a value of the power received by the portable equipment of a user.

An aspect of the invention also relates to a device for charging portable equipment of a user intended to be placed on board a vehicle, comprising at least two transmitter coils and having a charging surface capable of receiving said equipment for the charging thereof, said charging device periodically receiving a signal from the portable equipment during charging, said signal comprising a value representing a deviation between a charging power required by the portable equipment and a charging power received by said equipment, the charging device being characterized in that it comprises:
means for computing a charging conditions parameter and for comparing between said parameter and a predetermined threshold representing charging limit conditions;
means for simultaneously activating adjacent charging coils as a function of the result of said comparison;
first means for comparing between the value representing a deviation between a charging power required by the portable equipment and a charging power received by said equipment and a first threshold (TH1);
means for deactivating and activating the at least one adjacent charging coil as a function of the result of said comparison.

Preferably, the means for determining the charging conditions parameter and for comparing between said parameters and a predetermined threshold representing charging limit conditions, the means for simultaneously activating adjacent charging coils as a function of the result of said comparison, the first means for comparing between the value representing a deviation between a charging power required by the portable equipment and a charging power received by said equipment and a first threshold, and the means for deactivating and activating at least one of the adjacent charging coils as a function of the result of said comparison are in the form of software included in a microcontroller.

An aspect of the invention also relates to a computer program product, characterized in that it comprises a set of program code instructions, which, when they are executed by one or more processor(s), configure the one or more processor(s) to implement a charging method according to any one of the aforementioned features.

Finally, an aspect of the invention applies to any motor vehicle comprising a charging device according to any one of the aforementioned features.

### BRIEF DESCRIPTION OF THE DRAWINGS

Further features and advantages of aspects of the invention will become more clearly apparent from reading the following description. This description is purely illustrative and must be read with reference to the accompanying drawings, in which:

FIG. 1 schematically shows the charging device on which portable equipment of a user is placed, with the receiver coil of the equipment being aligned with a transmitter coil B1 of the charging device;

FIG. 2 schematically shows the charging device on which portable equipment of a user is placed, with the receiver coil of the equipment not being aligned with any of the transmitter coils B1, B2, B3 of the device;

FIG. 3 is a flow chart of the charging method according to an aspect of the invention;

FIG. 4 illustrates the AC-DC converter of the charging device, and the measures used to determine the charging conditions parameter according to an aspect of the invention.

### DETAILED DESCRIPTION OF THE PREFERRED EMBODIMENTS

FIG. 1 illustrates a charging device D intended to be placed on board a motor vehicle and comprising a charging surface S, on which portable equipment, for example, a mobile telephone P, of a user is placed. The charging device comprises three transmitter coils, a first coil B1, a second coil B2 and a third coil B3. The first coil B1 is centered in relation to the charging device D and in an upper plane, i.e. closer to the charging surface S than the plane in which the other two coils B2, B3 are located. This arrangement is only by way of an illustration, the three coils can be juxtaposed in the same plane and there can be more than three coils.

In FIG. 1, the receiver coil A1 of the mobile telephone P is aligned with the first coil B1, or upper coil B1, of the charging device D. With the two coils being aligned, the efficiency of the charging of the telephone P by the first coil B1 of the induction device D is therefore optimal. The charging device D has, in a previous step, detected the position of the mobile telephone P on the charging surface S with the receiver coil A1 located opposite the first coil B1, and has triggered the charging by activating said coil B1. This method for activating charging coils is known in the prior art and is carried out as previously described by means of the transmission of “digital pings” by the transmitter coils B1, B2, B3 of the device, and the reception of a presence message originating from the mobile telephone P. Since this activation method is known in the prior art, it will not be described in further detail herein.

As previously explained, with the charging device D not having any mechanism for holding the portable equipment P, or mobile telephone P in this example, said mobile telephone can, during accelerations or decelerations of the vehicle or as a result of vibrations due to the movement of the vehicle, move on the charging surface S and shift relative to the activated charging coil, in this instance coil 131 in this example.

This is illustrated in FIG. 2. In FIG. 2, the mobile telephone P has shifted relative to the first coil 131 and is now simultaneously located above part of the first coil 131 and above a larger part of the third coil B3. In this new position, and according to the prior art, with the charging no longer being optimal with the first coil B1, the charging stops (stopping charging can be triggered by the mobile telephone P), so that the charging device D can identify the new coil to be activated, in this instance the third coil B3, thus allowing optimal charging efficiency to be regained. This charging method of the prior art therefore temporarily stops the charging and, as previously specified, two notifications are sent to the user, one to notify them that charging has been stopped, and another to notify them that charging has restarted, which can be distracting when the user is driving.

An aspect of the invention proposes a charging method allowing the disadvantages of the prior art to be overcome, in this instance the charging method according to an aspect of the invention allows continuous charging, without interrupting charging due to the deactivation/activation of the charging coils caused by the movement of the telephone on the charging surface S.

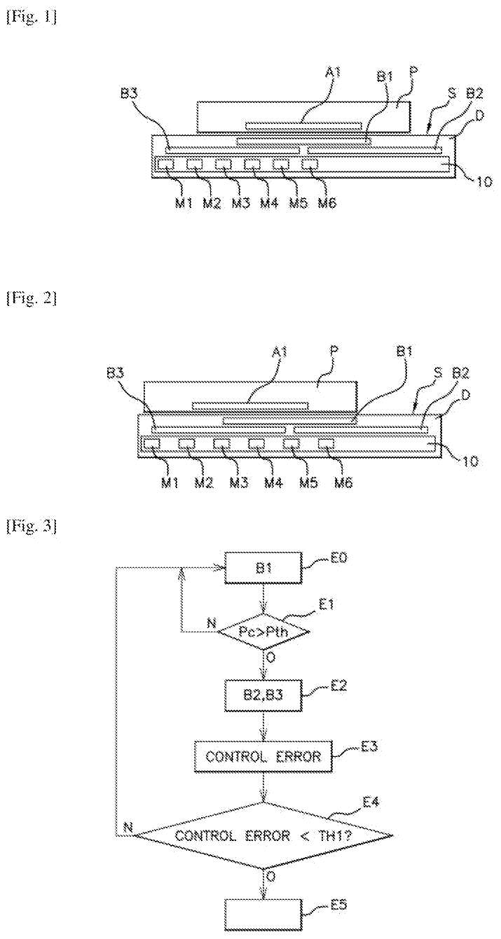

The charging method according to an aspect of the invention is illustrated in FIG. 3.

In a preliminary step E0, the mobile telephone P is placed on the charging surface S of the charging device D and a transmitter coil, for example, the first coil B1, is identified as the charging coil having the highest charging rate and is therefore activated to charge the mobile telephone (step E0).

In a first step E1, a charging conditions parameter Pc is computed and is compared to a predetermined threshold Pth representing charging limit conditions. If, for example, the charging conditions parameter is above the predetermined threshold, this means that the charging is not optimal and that the mobile telephone has shifted relative to the coil 131 and no longer receives all the field emitted from said coil.

According to an aspect of the invention, the charging conditions parameter Pc is computed as follows:

Pc=A+k1*VDC+k2*IDC+k3*IAC+k4*VAC+k5*RPP [Math 1]

with:
k1, k2, k3, k4, k5 being coefficients;
A being a digital value;
VDC being the value of the direct voltage (V) at the input of the AC-DC converter;
IDC being the value of the direct current (A) at the input of the AC-DC converter;
IAC being the value of the alternating current (A) circulating in the first coil 131;
VAC being the value of the alternating voltage (V) at the terminals of the first coil 131;
RPP being the value of the power (W) received by the mobile telephone P.

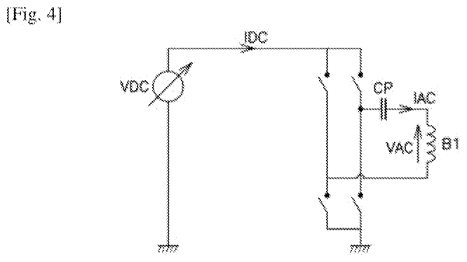

FIG. 4 illustrates the alternating voltage-direct voltage converter of the charging device, as well as the measures mentioned above and used to compute the charging conditions parameter.

The value of the power received by the mobile telephone P is periodically transmitted by said telephone P to the charging device.

Of course, the charging parameter Pc can be computed on the basis of any other type of mathematical formula, for example, exponential, logarithmic, computed on the basis of the VDC, IDC, IAC, VAC and RPP parameters.

In other words, the charging parameter Pc also can be computed, for example, on the basis of the following values, which are known to a person skilled in the art:
Qieff: charging efficiency, computed on the basis of RPP, VDC and IDC;
ESR: “Equivalent Serial Resistance” of the coil B1 of the charging device;
inductance of the coil 131;
Qfactor: or quality factor measured at the terminals of the first coil 131;
AC_phase: the value of the phase between two alternating current signals measured at the terminals of the first coil 131;
etc.

If the charging conditions parameter Pc is above the predetermined threshold Pth, then, in a second step (step E2), at least one of the coils adjacent to the coil B1 is activated in addition to the first coil B1, which has not been deactivated. For example, initially the second coil B2 is activated at the same time as the first coil B1.

If the charging conditions parameter Pc is below the predetermined threshold Pth, then the charging continues with the coil B1 and the coil B2 (or B3) is not activated.

In the event that the coil B2 is activated, said coil B2 therefore generates an electromagnetic flow. In the event that the mobile telephone P has shifted and is now also partly above the second coil B2, said mobile telephone will receive the electromagnetic field from each of the two coils B1, B2.

The mobile telephone P periodically sends a signal to the charging device D that comprises a value representing a deviation between the power required by the mobile telephone P and the power actually received by said telephone, this occurs in order to modulate and/or control the charging. This type of message is called “CONTROL ERROR” message in the WPC (“Wireless Power Consortium”) standard that defines the “Qi” standard. In this instance, the “CONTROL ERROR” message is in the form of a value, either representing a request to increase charging power, or representing a request to reduce charging power, depending on the actual power requirement of the mobile telephone P and the power supplied by the charging device D. The “CONTROL ERROR” message assumes a value ranging from −127 to +128 without units.

In this case, the mobile telephone P receiving the fields from the two coils sends, during a third step E3, a “CONTROL ERROR” message indicating a necessary reduction of the received power. This “CONTROL ERROR” information is received by the charging device D. In this case, the received power is too high and the “CONTROL ERROR” message requests a reduction in the charging power, for example, “CONTROL ERROR”=−20.

During a fourth step (step E4), the value representing the “CONTROL ERROR” deviation thus received is then compared to a first predetermined threshold TH1 representing a maximum reduction in charging that can only be received by activating a single transmitter coil.

If the value representing the “CONTROL ERROR” deviation is below said first threshold TH1, for example, TH1=−10, then the first coil B1 is deactivated, the second coil B2, for its part, continues to be activated, and the charging therefore continues with the second coil B2, without stopping charging during coil changeover, since the deactivation of the first coil B1 judiciously occurred after the activation of the second coil B2.

Otherwise, if the value representing the “CONTROL ERROR” deviation is above said first threshold TH1 (step E4), then the method returns to step E0, step E1 is repeated, and the subsequent steps (E2 to E5) are repeated for the other adjacent coil, in this example the third coil B3.

In order to be able to implement the charging method D according to an aspect of the invention, the charging device D further comprises:
a. means for computing the charging conditions parameter Pc and for comparing between said parameter and a predetermined threshold;
b. means for simultaneously activating charging coils;
c. first means for comparing between the value representing a “CONTROL ERROR” deviation between the charging power required by the mobile telephone P and the charging power actually received by said telephone and a first minimum threshold TH1;
d. means for deactivating and activating charging coils as a function of the result of said comparison.

The means for computing the charging conditions parameter and for comparing between the charging conditions parameter and the predetermined threshold representing charging limit conditions, the means for simultaneously activating charging coils, the first means for comparing between the value representing a “CONTROL ERROR” deviation and a first threshold TH1, and the means for deactivating and activating charging coils as a function of the result of said comparisons taken separately or in combination are in the form of software, included in a microcontroller, located in a printed circuit 10 of the charging device D.

Therefore, an aspect of the invention ingeniously allows charging to continue with another coil, even when the mobile telephone P shifts on the charging surface, without interrupting and resuming charging and therefore without distracting notifications for the driver.

1. A method for induction charging portable equipment of a user using a charging device comprising at least two transmitter coils and having a charging surface capable of receiving said equipment for the charging thereof, said charging device periodically receiving a signal from the portable equipment during charging, said signal comprising a value representing a deviation (“CONTROL ERROR”) between a charging power required by the portable equipment and a charging power received by said equipment, the method comprising:
a) placing the portable equipment on the charging surface and activating a first charging coil;
b) determining a charging conditions parameter on the basis of measurements of the charging device;
c) if the charging conditions parameter is greater than a predetermined threshold representing charging limit conditions meaning that the charging is not optimal, then d) activating another coil adjacent to said first charging coil whilst keeping the first charging coil activated;
e) if the value representing the deviation (“CONTROL ERROR”) between the required charging power and the received power is less than a first threshold, then
f) deactivating the first coil;
g) otherwise, repeating the preceding steps.

2. The charging method as claimed in claim 1, wherein the charging conditions parameter is computed on the basis of a value of the direct voltage at the input of an AC-to-DC converter connected to the first charging coil, a value of the direct current at the input of said converter, a value of the alternating current circulating in the first charging coil, a value of the alternating voltage at the terminals of said first charging coil and a value of the power received by the portable equipment of a user.

3. A device for charging portable equipment of a user intended to be placed on board a vehicle, comprising at least two transmitter coils and having a charging surface capable of receiving said equipment for the charging thereof, said charging device periodically receiving a signal from the portable equipment during charging, said signal comprising a value representing a deviation (“CONTROL ERROR”) between a charging power required by the portable equipment and a charging power received by said equipment, the charging device comprising:
a) means for computing a charging conditions parameter (Pc) on the basis of measurements of the charging device and for comparing between said parameter and a predetermined threshold representing charging limit conditions, meaning that the charging is not optimal;
b) means for simultaneously activating adjacent charging coils as a function of the result of said comparison;
c) first means for comparing between the value representing the deviation (“CONTROL ERROR”) between a charging power required by the portable equipment and a charging power received by said equipment and a first threshold; and
d) means for deactivating and activating one of the adjacent charging coils as a function of the result of said comparison.

4. The charging device as claimed in claim 3, wherein the means for determining the charging conditions parameter and for comparing between said parameters and a predetermined threshold representing charging limit conditions, the means for simultaneously activating adjacent charging coils as a function of the result of said comparison, the first means for comparing between the value representing a deviation (“CONTROL ERROR”) between a charging power required by the portable equipment and a charging power received by said equipment and a first threshold, and the means for deactivating and activating at least one of the adjacent charging coils as a function of the result of said comparison are in the form of software included in a microcontroller.

5. A non-transitory computer program product, comprising a set of program code instructions, which, when they are executed by one or more processor(s), configure the one or more processor(s) to implement a charging method as claimed in claim 1.

6. A motor vehicle comprising a charging device as claimed in claim 3.
